(19) United States
(12) Patent Application Publication
(10) Pub. No.: US 2007/0175405 A1
(43) Pub. Date: Aug. 2, 2007

(54) Device for teat washing in milkers

(76) Inventor: Giuliano Vecchia, Azzanello (Cremona) (IT)

Correspondence Address: YOUNG & THOMPSON, 745 SOUTH 23RD STREET, 2ND FLOOR, ARLINGTON, VA, 22202, US

(21) Appl. No.: 11/490,072

(22) Filed: Jul. 21, 2006

(30) Foreign Application Priority Data
Jul. 21, 2005 (IT) MI2005U000266

(51) Int. Cl. A01J 3/00; A01J 5/00

(52) U.S. Cl. 119/670; 119/14.01

(57) ABSTRACT

A device for milker teat washing includes a box-shaped body (1) containing two pairs of counter-rotating and partially overlapping brushes (2, 3, 4, 5). The box-shaped internal components, except the rotating ones, are products integral with a base stuck to the box-shaped body (1). Preferably, within the box-shaped body there are two pipes (11, 12) adapted to provide water feeding, disposed symmetrically with respect to the zone where the teat is inserted into the box-shaped body (1).

### FIELD OF THE INVENTION

The present invention refers to a device for teat washing in milkers, particularly in cattle.

### BACKGROUND OF THE INVENTION

Devices for milker teat washing after milking are well-known in the art.

EP 0 399 132 discloses an automatic device for teat washing of cows or other milkers, comprising rotating brushes and means to convey a washing fluid. The device provides two brushes that rotate in opposite direction, partially overlapping, in order to generate a suction action on the teat when it is by the overlapping zone of the brushes. A third brush can clean the tip of the teat sucked by the other two.

EP 0 514 764 discloses a device for milker teat automatic washing and drying, comprising a washing head with rotating brushes, driving means generating a torque, at least one tank to store washing fluids, pumping means to pump fluids to the washing head, first means to convey washing fluids from the tank to the pumping means, second means to convey washing fluids from said pumping means to the washing head, a driving cable to transfer the torque to the rotating brushes from said driving means. The second means to convey washing fluid are associated with the driving cable.

EP 0 514 765 discloses a device for milker teat washing, comprising a box-shaped body with an opening to insert a teat therein along an insertion direction defined when the device is applied to the teat to be washed, a first brush pair rotating in opposite directions in the box-shaped body, with the bristles slightly overlapping and applying a suction along said insertion direction towards the interior of the box-shaped body. Said device comprises a second pair of brushes rotating in opposite directions and positioned downstream of said first pair along insertion direction, said second pair generating a thrust force in the direction opposite to the first pair suction.

European Patent 0 514 766 refers to a device for milker teat washing, comprising a box-shaped body with an opening to insert a teat along an insertion direction, defined applying the device to the teat, and an handle protruding from the box-shaped body along an axis defined by its longitudinal extension. The handle comprises means to connect it to the box-shaped body in a interval of different angular positions, defined by an angle comprised between insertion direction and handle axis. If necessary, angular position adjusting means can be provided.

The embodiments described so far involve remarkable advantages as to practicalness and handiness. They involve, however, not irrelevant production costs as they require the molding of various, sometimes even small, pieces, which are then to be connected, for example screwing them, to the main body of the device. The connection by screwing could in addition turn out to be loose after a prolonged use.

### SUMMARY OF THE INVENTION

All the drawbacks exposed above are brilliantly solved by the present invention, referring to a device for milker teat washing, comprising a box-shaped body containing two pairs of counter-rotating and partially overlapping brushes, characterised in that the box-shaped internal components, except the rotating ones, are integral products.

### BRIEF DESCRIPTION OF THE DRAWINGS

The present invention is now illustrated in a more detailed way referring to the accompanying drawings, in which:

FIG. 1 is a total perspective, partially sectional, exploded view;

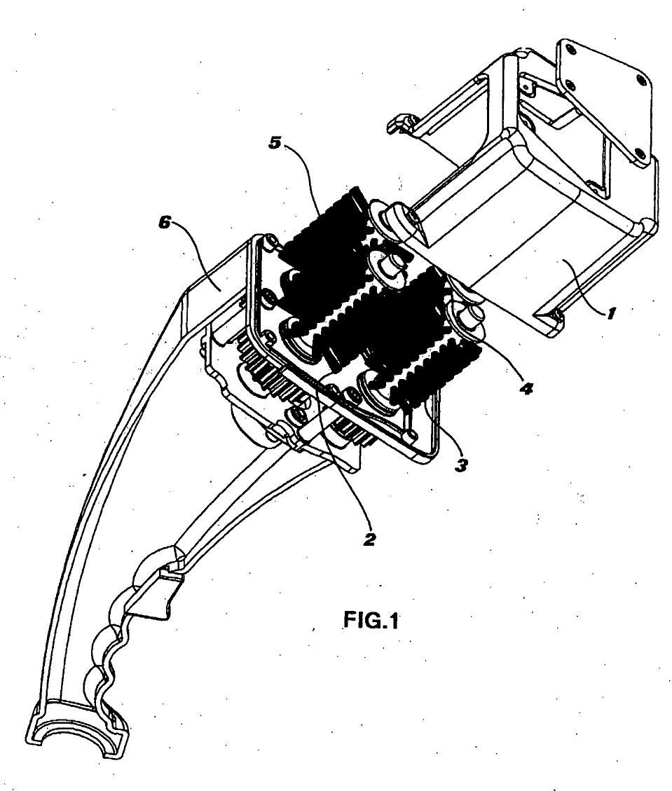

FIG. 2 is a detail of FIG. 1; and

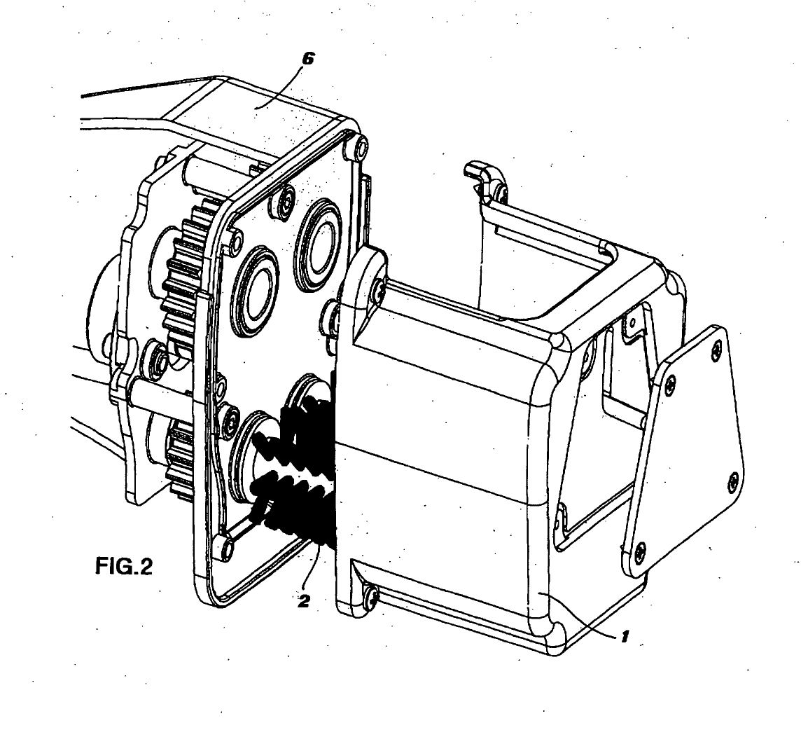

FIGS. 3A-F are plan views of components of the device according to the present invention.

### DESCRIPTION OF A PREFERRED EMBODIMENTS

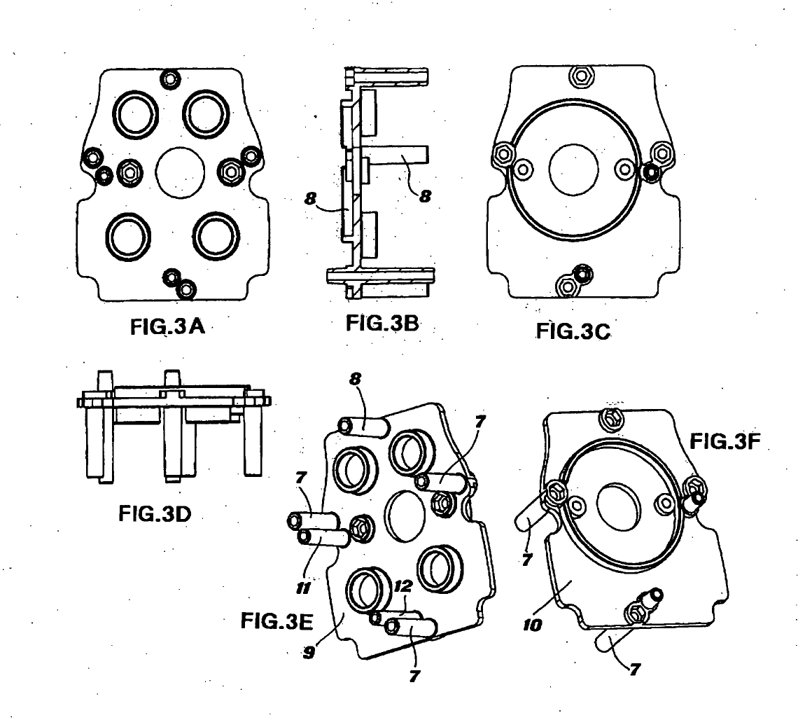

The device according to the present invention is composed by a box-shaped body 1, within which two pairs of brushes 2, 3, 4 and 5 are contained. The brushes 2 and 3 and 4 and 5 are contra-rotating and partially overlapping, so to achieve a double suction and thrust action on the teat, so to produce an accurate cleaning. A portion of the handle 6 is fastened to the box-shaped body 1, bolted or stuck to the box-shaped body 1. As it can be easily seen in FIGS. 3B, 3E and 3F, the pins 7 for fastening and for carrying the brushes are formed integrally with the bases 8, 9 and 10. Also integral with the base 9 are two pipes 11 and 12, apt to provide water feeding. The bases 8, 9 and 10, with the described components, can in turn be stuck within the box-shaped body 1. The disposition of these pipes 11, 12 according to FIG. 3E is particularly advantageous as it allows water feeding to the teat from more than a point and in particularly favourable positions for the cleaning, being, for example, positioned symmetrically with respect to the area within which the teat is received.

The operation of the device, subject of the present invention, is extremely simple. The teat to be washed is inserted into the box-shaped element 1 and is passed through the first couple of counter-rotating brushes 2, 5 carrying out dirt suction. Subsequently, the teat tip is brought into contact with the other two brushes 3, 4 thrusting on it, so to remove the other dirty parts. At the same time, water is fed from the pipes 11, 12, coming on the teat from two directions, so to be available for the washing with the brushes 2, 3, 4 and 5.

The presence of the handle 6 makes the device utilisation easy as it can be applied to the desired teat in a extremely simple and quick way.

The implementation according to the present invention achieves a certain amount of advantages, which are not obtainable with the devices of the known art.

The integral implementation of the components permits to utilise a single mould rather than a plurality of moulds. In view to the cost that these moulds generally have, the production costs turn out to be remarkably reduced and not even for a moment comparable to those to be met in the past. Further, the integral implementation itself allows to obtain a greater strength and stability of the device, without risks regarding screw loosening with backlashes or even component detachments.

The implementation with the two pipes 11 and 12, rather than with the usual single little pipe, and their location within the box-shaped body 1 cause a remarkably improved washing action, as water can reach also teat zones that were dry scraped by the brushes before. In addition to a more accurate cleaning, also a greater comfort of the animal is obtained.

1. Device for milker teat washing, comprising a box-shaped body (1) containing two pairs of counter-rotating and partially overlapping brushes (2, 3, 4, 5), characterised in that the box-shaped body internal components, except the rotating ones, are products integral with a base (8, 9, 10).

2. Device as in claim 1, characterised in that a portion of the handle (6), bolted to the box-shaped body (1) is fastened to the box-shaped body (1).

3. Device as in claim 1, characterised in that within the box-shaped body are two pipes (11, 12) apt to provide water feeding.

4. Device as in claim 3, characterised in that said pipes (11, 12) are positioned symmetrical with respect to the zone where the teat is inserted into the box-shaped body (1).

5. Device as in claim 1, characterised in that said bases (8, 9, 10) are stuck within the box-shaped body (1).

6. Device as in claim 2, characterised in that within the box-shaped body are two pipes (11, 12) apt to provide water feeding.
